(19) United States
(12) Patent Application Publication
(10) Pub. No.: US 2023/0175280 A1
(43) Pub. Date: Jun. 8, 2023

(54) EMBER SCREEN

(71) Applicant: COMMERCIALISATION EXPRESS PTY LTD, Salisbury Heights (AU)

(72) Inventor: John RIEMELMOSER, Salisbury Heights (AU)

(73) Assignee: COMMERCIALISATION EXPRESS PTY LTD, Salisbury Heights (AU)

(21) Appl. No.: 17/917,260

(22) PCT Filed: Apr. 14, 2021
(86) PCT No.: PCT/AU2021/050332

§ 371 Date: Oct. 6, 2022

(30) Foreign Application Priority Data
Apr. 14, 2020 (AU) 2020901178

(51) Int. Cl. E04H 9/14; A62C 3/02

(52) U.S. Cl. CPC E04H 9/14; A62C 3/0214; A62C 3/0257

(57) ABSTRACT

An ember screen for protecting a building from ember attack comprising a series of individual fire-resistant screens joined laterally. The screens are sealedly attached to the building above any fire susceptible features, typically to a gutter. The bottom of the screens are held in place and sealed to the ground with the aid of sand bags.

### FIELD OF THE INVENTION

The present invention relates to a screen for protecting buildings from ember attacks.

### BACKGROUND TO THE INVENTION

Ember attacks that accompany a fire front are responsible for the loss of a significant number of buildings. It is relatively easy to protect a building from an ember attack by quickly attending to any small spot fires that develop. However, if left unattended the small spot fires can quickly take hold and destroy a building. This tempts many people to stay and defend their buildings when a bush fire is nearby. The unpredictable path of a bush fire often places those staying to defend their buildings in danger and depending on the terrain may trap them in their buildings. It also endangers the emergency services personal when tasked to rescue them. To avoid putting lives at risk the best policy is to evacuate buildings in bush fire zones, however this often leads to buildings that what would have otherwise been easy to defend being destroyed by ember attacks. Measures such as leaving sprinklers running often fail due to insufficient water supplies, power outages and petrol powered generators/pumps running out of fuel. Fixed Sprinkler systems for this purpose are also prohibitively expensive

Suggestions have been put forth to design buildings to resist ember attacks by removing features such as eaves, verandas and decks which are known to trap embers. Unfortunately removing such features greatly reduces the desirability of a building and does not address the vast number of existing buildings with these features.

The present applicant has identified the need for a simple and economical way to protect buildings from ember attacks that is retrofittable and compatible with the variety of existing buildings, and that can be quickly and easily deployed.

The object of this invention is to provide an ember screen to alleviate the above problems, or at least provide the public with a useful alternative.

### SUMMARY OF THE INVENTION

In a first aspect the invention provides an ember screen for protecting a building from ember attack, the screen comprising a series of individual screens of fire resistant material joined together laterally.

Preferably the top section of the screen is attached to the building via the gutter of the building and the screen is attached to the gutter by being sandwiched between the gutter and an elongate member, and wherein the elongate member is held in place with a clamp.

The clamp may be a screw clamp, or a spring clamp.

Preferably the top portion of the screen lies over the gutter of the building.

The top section of the screen may also be attached to a horizontal bracket attached to the building.

In preference the individual screens comprise splines along their lateral edges, and the individual screens are joined together via joiners comprising channels for accepting the splines of the adjacent individual screens. The joiners may comprise separate sections that are longitudinally joined together.

Preferably the screen further comprises swatches of screen material placed over the top ends of the joiners and over adjacent individual screens and attached to the gutter.

The adjacent individual screens may be joined together via a corner piece comprising a triangular screen.

Preferably the individual screens comprise a ground flap at their bottom end for accepting a weighted element to seal the screens to the ground, and a sealing flap in proximity to their bottom end for covering the weighted element.

In preference the weighted element is a sandbag or a water filled foil bladder

Preferably the ground flaps and the sealing flaps are wider than the width of the individual screens such that the flaps of adjacent individual screens overlap.

The fire-resistant material may be selected from the group of aluminium sarking, intumescent material, and metallic fly screen, and preferably the fire-resistant material includes a fiberglass screen backing.

A side of the ember screen may be attached to the building via the spline of an individual screen engaging with a bracket for accepting the spline attached to the building.

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows.

FIG. 1A shows a house before being fitted with an ember screen of the invention, and FIG. 1B shows the house fitted with an ember screen of the invention

FIG. 2 is a side view showing how the top section of the ember screen is attached to the gutter of the house

FIG. 3 is a side view showing how the bottom section of the ember screen is secured with a sandbag

FIG. 4A shows an end view of a joiner used to join individual screens together, and FIG. 4 B shows the joiner in use joining two individual screens together.

FIG. 5 shows details of an ember screen from front on.

### DRAWING COMPONENTS

The drawings include the following integers.
10 building without ember screen
10′ building with ember screen fitted
11 walls
12 roof
13 gutters
14 gutter front wall
15 windows
16 doorway
18 ground
20 ember screen
30 individual screen
30′ individual screen (connected to wall)
30″ individual scree (passing around corner)
31 spline
32 top section of screen
33 ground flap
34 cover flap
40 screen joiner
44 web
46 spline channels
48 connector
50 wall joiner
52 fasteners
60 long elongate member
62 short elongate member
70 C-clamp
72 clamp pad
80 swatch
90 sandbag
95 fireproof adhesive tape

### DETAILED DESCRIPTION OF THE INVENTION

The following detailed description of the invention refers to the accompanying drawings. Wherever possible, the same reference numbers will be used throughout the drawings and the following description to refer to the same and like parts. Dimensions of certain parts shown in the drawings may have been modified and/or exaggerated for the purposes of clarity or illustration, particularly thin materials. Materials that are in contact with each other may also be shown separated for representational convenience.

The present invention provides an ember screen in the form of a series of individual screens that join together laterally to form a protective screen against ember attacks. The individual screens can be quickly and easily deployed on a variety of building structures, preferably being clamped at their top to a gutter and held in place at their bottom with the aid of sandbags.

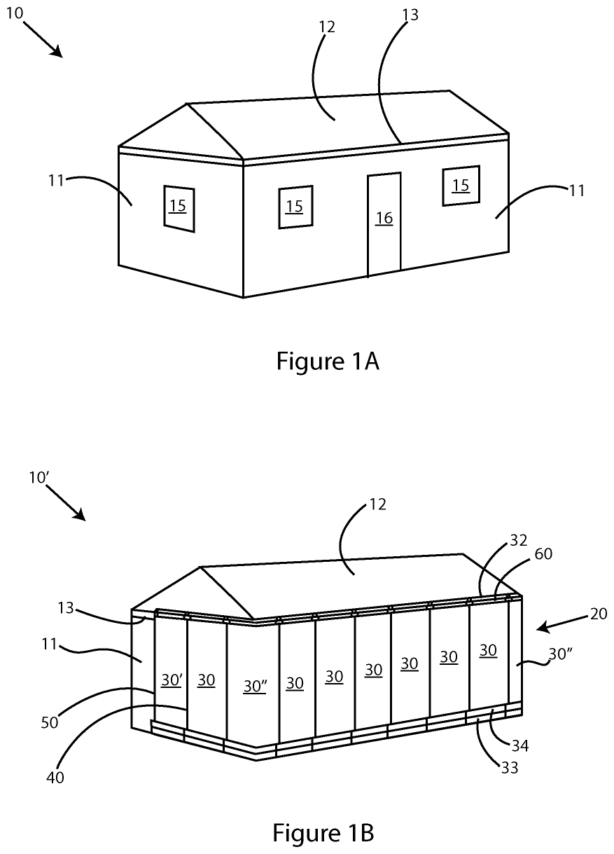

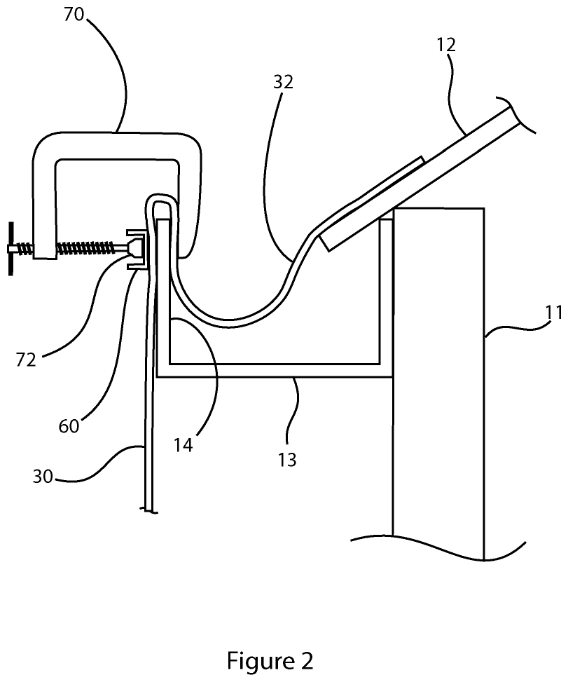

FIG. 1A shows an example building 10 before being fitted with an ember screen 20 of the invention. The building 10 comprises walls 11 with roof 12 and gutters 13, and windows 15 and a doorway 16 which would be susceptible to an ember attack. In FIG. 1B the building 10′ has been fitted with an ember screen 20 according to a preferred embodiment of the invention. The ember screen 20 is comprised of a series of individual screens 30 joined laterally by screen joiners 40. In this example an individual screen 30′ is attached at on side to the wall 11 with aid of wall joiner 50. Some of the individual screens 30″ pass around the corners of the building. A series of clamps 70 (seen inn FIG. 2) and elongate members 60 near the top of the ember screen secure it to the gutter 13 whilst the top section of the ember screen 32 lies over the gutter. The bottom section of the ember screen includes overlapping ground flaps 33 and cover flaps 34 which covers sandbags which holds the screen down and seals it to the ground.

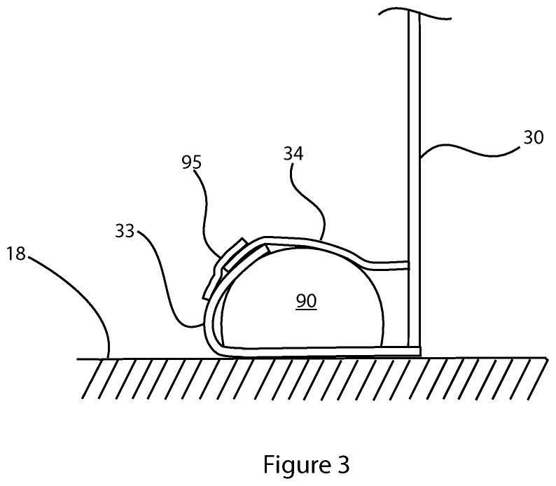

FIGS. 2 and 3 respectively show the top section and bottom section of a fitted ember screen 20. The scale of the components in these drawings have been greatly exaggerated for representational convenience.

At the top of the ember screen as seen in FIG. 2, the top section 32 of an individual screen 30 drapes over the front wall 14 of the gutter 13 and then onto the roof 12. A long elongate member 60, preferably in the form of a C-channel, sandwiches the screen 30 against the front wall 14 of the gutter 13 and is held in place by C-clamp 70 with its pad 72 sitting in the C-channel. Alternatively, a spring clamp may be used, but a C-clamp is preferred as its screw action can be easily manipulated to provide a high clamping force. The C-channel holding the screen tightly against the gutter provides an ember proof seal.

At the bottom of the ember screen as seen in FIG. 3, the individual screen 30 includes a ground flap 33 sitting on the ground 18 on top of which sits a sandbag 90. The weight of the sandbag holds the screen down and encourages it to conform to the contours of the ground thus providing an ember proof seal to the ground. Other heavy items may be used in place of the sandbags such as a water filled foil bladder. Cover flap 34 emanates from the screen approximately 200 mm above the ground flap 33 and drapes over the top of the sandbag 90 to protect it against embers or flames. The two flaps are secured together with an adhesive fireproof tape 95. Alternatively, pins can be pushed through the two flaps and into the sandbag to secure them in place.

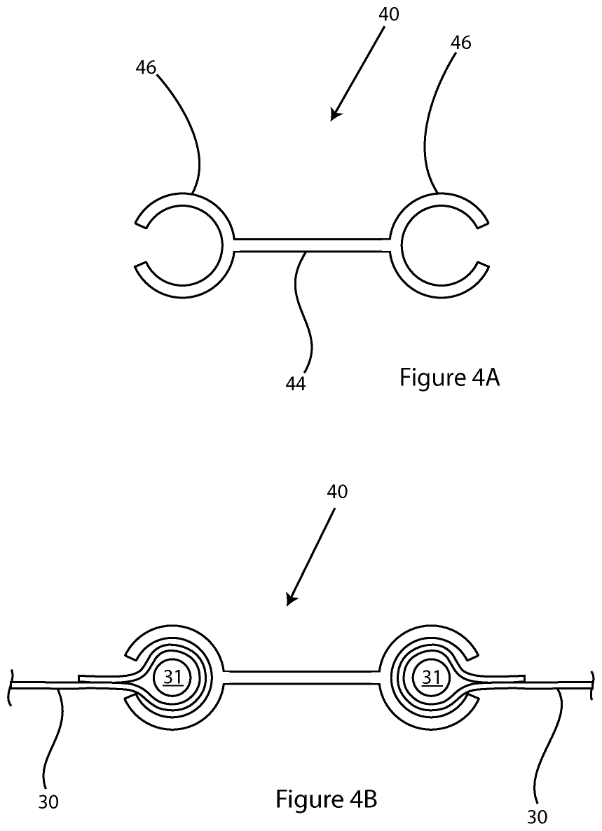

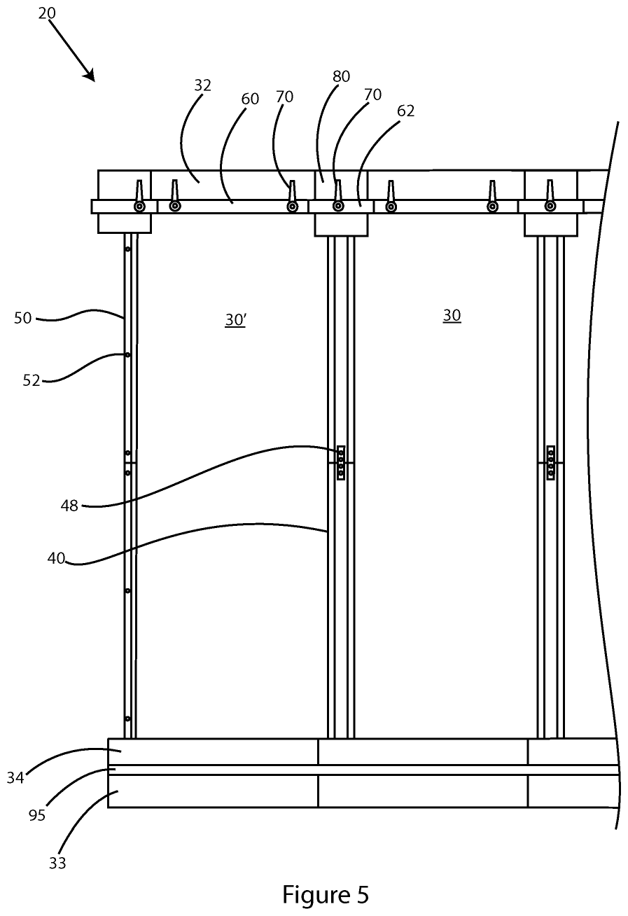

FIG. 4A shows an end view of a joiner 40, which is shown in FIG. 4B holding two individual screens 30 together laterally to provide an ember proof seal. The sides of the individual screens wrap around to encase a spline 31, which is slid into spline channels 46 of the joiner 40. The spline channels 46 are held apart by a web 44. The web allows short screen joiner sections to be joined together end on end with the aid of a connector 48 to produce a long joiner 40 as seen in FIG. 5. The connector 48, preferably a C-channel, is secured to each of the abutting joiner sections with fasteners, typically screws engaging with nuts. Having a joiner 40 formed from smaller sections allows it to be easily stored and transported in its disassembled state. The individual sections make the assembly of a complete ember screen 20 easier as they can be fitted to the individual screens 30 before being joined together. If desired horizontal bracing members (not shown) may also be connected between laterally adjacent joiners 40 to provide a more rigid screen, with the joiner webs 44 providing suitable attachment points.

FIG. 5 shows a section of ember screen 20 from front on to further illustrate the various elements. A first individual screen 30′ is attached along one side to a wall via wall joiner 50 which is similar to the joiner 40, but has only one spline channel and is attached to a wall by fasteners 52, typically masonary anchors. The joiner 50 provides a ember proof seal between the wall and the ember screen. Care may be needed to ensure that the wall behind the joiner 50 is flat by use of cement or the like. The first individual screen 30′ is connected to and adjacent individual screen 30 by joiner 40 which is formed from two smaller joiner sections held together end on end by connector 48. The individual screens 30 and 30′ are secured to the ground and provide an ember proof seal with ground flaps 33 under and covering flaps 34 wrapping around sandbags (obscured) and held together with fireproof tape 95. The ground flaps and covering flaps of adjacent individual screens overlap each other. The top section 32 of the individual screens is secured to the gutters of the building by clamps 70 and elongate members 60. To ensure an ember proof seal between adjacent top sections a swatch 80 of screen material, typically 300 mm×300 mm, is placed over the top of the joiners 40 an over the adjacent top sections. The swatch 80 is held in place by clamps 70 and short elongate members 62, in the same manner that the top sections are secured by clamps 70 and long elongate members 60. The short elongate members 62 and long elongate members are sized and positioned to form a contiguous seal against the gutter. When putting an ember screen together any gaps may be sealed with the aid of fireproof adhesive tape.

The individual screens 30 and 30′ typically hang vertically, but may be angled outwards towards the bottom if desired, in which case a triangular screen is provided for wrapping around outside corners. Having the screens angled helps direct embers up and over the screens.

The example ember screens shown have been secured at their top to a gutter. For gable ends where no gutter is present a horizontal bracket can be attached to the wall and the screens attached in a similar manner.

The ember screen is intended for temporary use only and to be quickly erected in anticipation of a possible approaching fire front. Preferably this is done well before the fire front approaches to allow the building occupiers to safely evacuate. To ensure that the screen can be fitted where desired when needed, the owner is encouraged to do a test fitting to ensure that there are sufficient components and that they are trimmed to size if needed. The screens, joiners and elongate members are preferably cut to length to suit the specific details of the building. As the top end of the screens is devoid of features it can be cut to length as desired.

The screen material maybe any suitable fire-resistant or intumescent material that can be easily rolled up. Stainless steel or bronze flyscreen may be used, however this solution is relatively expensive and also heavy to handle. Preferably the screen material is aluminium sarking with a fibreglass mesh backing for strength. PVC coated fibreglass, preferably coated with an intumescent paint, is another option.

The reader will now appreciate the present invention which provides an ember screen for protecting a building that is inexpensive and readily deployed when needed, and suitable for fitting to a wide variety of buildings.

Further advantages and improvements may very well be made to the present invention without deviating from its scope. Although the invention has been shown and described in what is conceived to be the most practical and preferred embodiment, it is recognized that departures may be made therefrom within the scope of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the present specification and claims (if any), the word “comprising” and its derivatives including “comprises” and “comprise” include each of the stated integers but does not exclude the inclusion of one or more further integers.

1. An ember screen for protecting a building from ember attack, the screen comprising a series of individual screens of fire-resistant material joined together laterally.

2. The ember screen as in claim 1, wherein a top section of the screen is adapted to be attached to the building.

3. The ember screen as in claim 2, wherein the screen is adapted to be attached to a gutter of the building.

4. The ember screen as in claim 3, wherein the screen is adapted to be attached to the gutter by being sandwiched between the gutter and an elongate member, and wherein the elongate member is held in place with a clamp.

5. The ember screen as in claim 4, wherein the clamp is a screw clamp.

6. The ember screen as in claim 4, wherein the clamp is a spring clamp.

7. The ember screen as in claim 3, wherein a top portion of the screen is adapted to lay over the gutter of the building.

8. The ember screen as in claim 2, wherein the top section of the screen is adapted to be attached to a horizontal bracket attached to the building.

9. The ember screen claim 1, wherein each individual screen of the series of individual screens has splines along their lateral edges, and wherein the individual screens are joined together via joiners comprising channels for accepting the splines of the adjacent individual screens.

10. The ember screen as in claim 9, wherein the joiners comprise separate sections that are longitudinally joined together.

11. The ember screen as in claim 9, wherein the screen further comprises swatches of screen material placed over top ends of the joiners and over adjacent individual screens of the series of individual screens, and wherein the swatches of screen material are attached to the gutter.

12. The ember screen as in claim 9, wherein adjacent individual screens of the series of individual screens are joined together via a corner piece comprising a triangular screen.

13. The ember screen claim 1, wherein individual screens of the series of individual screens have a ground flap at their bottom end for accepting a weighted element to seal the individual screens to the ground.

14. The ember screen as in claim 13, wherein each of the individual screens has a sealing flap in proximity to their bottom end for covering the weighted element.

15. The ember screen as in claim 13, wherein the weighted element is a sandbag.

16. The ember screen as in claim 13, wherein the weighted element is a water filled foil bladder.

17. The ember screen as in claim 14, wherein the ground flaps and the sealing flaps are wider than a width of the individual screens such that the ground flaps and the sealing flaps of adjacent individual screens overlap.

18. The ember screen claim 1, wherein the fire-resistant material is selected from the group of aluminium sarking, intumescent material, and metallic fly screen.

19. The ember screen as in claim 18, wherein the aluminium sarking and intumescent material include a fiberglass screen backing.

20. The ember screen as in claim 1, wherein a side of the ember screen is adapted to be attaching to the building via a spline of an individual screen engaging with a bracket for accepting the spine attached to the building.
